(19) United States
(12) Patent Application Publication
(10) Pub. No.: US 2020/0014457 A1
(43) Pub. Date: Jan. 9, 2020

(54) Multi-Layer NOMA Wireless Communication for Repeating Transmission of a Transport Block

(71) Applicant: Google LLC, Mountain View, CA (US)

(72) Inventor: Chien-Hsin Tang, Taipei City (TW)

(73) Assignee: Google LLC, Mountain View, CA (US)

(21) Appl. No.: 16/427,712

(22) Filed: May 31, 2019

Related U.S. Application Data
(60) Provisional application No. 62/693,836, filed on Jul. 3, 2018.

(51) Int. Cl. H04B 7/155; H04W 74/00; H04L 5/00

(52) U.S. Cl. CPC H04B 7/155; H04W 88/02; H04L 5/0055; H04W 74/004

(57) ABSTRACT

The present disclosure describes methods and systems applicable to multi-layer non-orthogonal multiple access (NOMA) wireless communication for repeating transmission of a transport block (TB). The methods and systems are applicable to transmitting one transport block on multiple NOMA layers, where the same transport block on the multiple NOMA layers have different redundancy versions (RVs). By combining multiple transmissions of the one transport block on the multiple NOMA layers, a base station can obtain a correctly decoded transport block and can successfully decode the data therein.

### RELATED APPLICATION

This application claims priority under 35 U.S.C. § 119(e) to U.S. Provisional Patent Application 62/693,836, filed on Jul. 3, 2018, which is incorporated herein by reference in its entirety.

### BACKGROUND

Multiple access (MA) wireless-communication techniques are an important part of a wireless-communication network. In general, multiple access wireless-communication techniques provide for two or more User Equipment (UE) devices, such as smartphones, to share resources of a wireless-communication network in an efficient and effective manner. The resources may include, for example, physical resource blocks that span a time, a frequency, or a code domain that the UE devices share while communicating with a base station that supports the wireless-communication network.

Today, wireless network communication providers are implementing non-orthogonal multiple access (NOMA) techniques to support Fifth-Generation New Radio (5G NR) wireless communications. Using NOMA techniques, a UE device may transmit a multi-branch data stream to the base station. Multiple MA resources support the transmission of the multi-branch data stream, where each MA resource consists of at least one physical resource block and an MA signature, which in effect, distinguishes data streams of the multi-branch data stream.

The use of grant-free transmissions removes resource-scheduling restrictions for wireless-communication network and NOMA techniques remove capacity limitations that other techniques, such as orthogonal multiple access (OMA) techniques, might impose upon the wireless-communication network. However, the use of multi-branch NOMA wireless-communication techniques increases the complexity of distinguishing signals and decoding data at the base station, especially when multiple user devices perform multi-branch NOMA transmissions and the base station is tasked with consistently distinguishing the signals and decoding data from the multiple user devices.

### SUMMARY

The present disclosure describes methods and systems applicable to multi-layer non-orthogonal multiple access (NOMA) wireless communication for repeating transmission of a transport block (TB). The methods and systems are applicable to transmitting one transport block on multiple NOMA layers, where the same transport block on the multiple NOMA layers have different redundancy versions. By combining multiple transmissions of the one transport block on the multiple NOMA layers, a base station can obtain a single transmission of the transport block and can successfully decode the data therein.

The described methods and system accommodate combinations of underlying, interrelated techniques. The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, a reader should not consider the summary to describe essential features nor limit the scope of the claimed subject matter.

### BRIEF DESCRIPTION OF THE DRAWINGS

This document describes details of one or more aspects of multi-layer NOMA wireless communication for repeating transmission of a TB. The use of the same reference numbers in different instances in the description and the figures may indicate like elements:

FIG. 1 illustrates an example operating environment in which various aspects of multi-layer NOMA wireless communication for repeating transmission of a transport block can be implemented.

FIG. 2 illustrates example details of a user device and a base station supporting various aspects of multi-layer NOMA wireless communication for repeating transmission of a TB.

FIG. 3 illustrates an example diagram representing rate-matching and HARQ functionality.

FIG. 4 illustrates an example method for detecting data transmitted from a wireless device in accordance with various aspects of multi-layer NOMA wireless communication for repeating transmission of a TB.

FIG. 5 illustrates an example method for causing a base station to detect data transmitted from a user device in accordance with various aspects of multi-layer NOMA wireless communication for repeating transmission of a TB.

FIG. 6 illustrates an example method for detecting data transmitted from a wireless device in accordance with various aspects of multi-layer NOMA wireless communication for repeating transmission of a TB.

FIG. 7 illustrates an example method for causing a base station to detect data transmitted from a user device in accordance with various aspects of multi-layer NOMA wireless communication for repeating transmission of a TB.

### DETAILED DESCRIPTION

Grant-free UpLink (UL) transmission is a paradigm in which user devices perform UL transmissions autonomously without being scheduled by the base station. In this case, it is assumed that the data transmission without grant is based on pre-configuration of resources. The method for the pre-configuration may be Radio Resource Control (RRC) signaling (also called higher-layer signaling), broadcast signaling, and so on. After the base station pre-configures the resources for user devices, each of the user devices autonomously transmits data on the resources. The base station receives the UL data using a predefined detection and/or decoding method on the resources.

NOMA wireless-communication techniques take advantage of non-orthogonal resource differences among user devices to improve communication efficiencies within a wireless-communication spectrum. In addition, non-orthogonal resource allocation is suitable for connecting a large number of user devices to a base station. With grant-free transmission used in the system, NOMA transmission is less restricted by the number of available physical resource blocks and their scheduling granularity.

In a NOMA scheme, a user device performs data transmission by using a multiple access (MA) resource. In at least one example, the MA resource includes a physical resource (e.g., time-frequency resource) and an MA signature. The MA signature is an entity distinguishing its data stream from others in multi-branch transmissions. The multi-branch transmissions may be considered a plurality of NOMA layers (also referred to as a plurality of single transmissions), each of which transmits a single data stream on the same physical resource through NOMA. In aspects, a transmitter may use different MA resources to transmit data, which indicates that the transmitter uses different MA signatures and/or different time-frequency resources to transmit the data. Generally, on a time-frequency resource, one NOMA layer (or one MA resource) cannot carry multiple transport blocks because the multiple transport blocks are considered different information streams that are individually processed on different NOMA layers. If a user device, such as a UE device, transmits multiple-TB data (e.g., more than one transport block) to a base station by performing multi-branch NOMA transmissions on a time-frequency resource, the user device uses multiple NOMA layers (e.g., multiple MA resources) to transmit the transport blocks to the base station, and the user device cannot transmit more than one transport block to the base station on only one NOMA layer. Therefore, if a user device transmits transport blocks to a base station by using NOMA layers, the number of transport blocks is necessarily not more than the number of the NOMA layers.

While features and concepts of the described systems and methods for multi-layer NOMA wireless communication for repeating transmission of a transport block can be implemented in any number of different environments, systems, devices, and/or various configurations, aspects of multi-layer NOMA wireless communication for repeating transmission of a transport block are described in the context of the following example devices, systems, and configurations.

Operating Environment

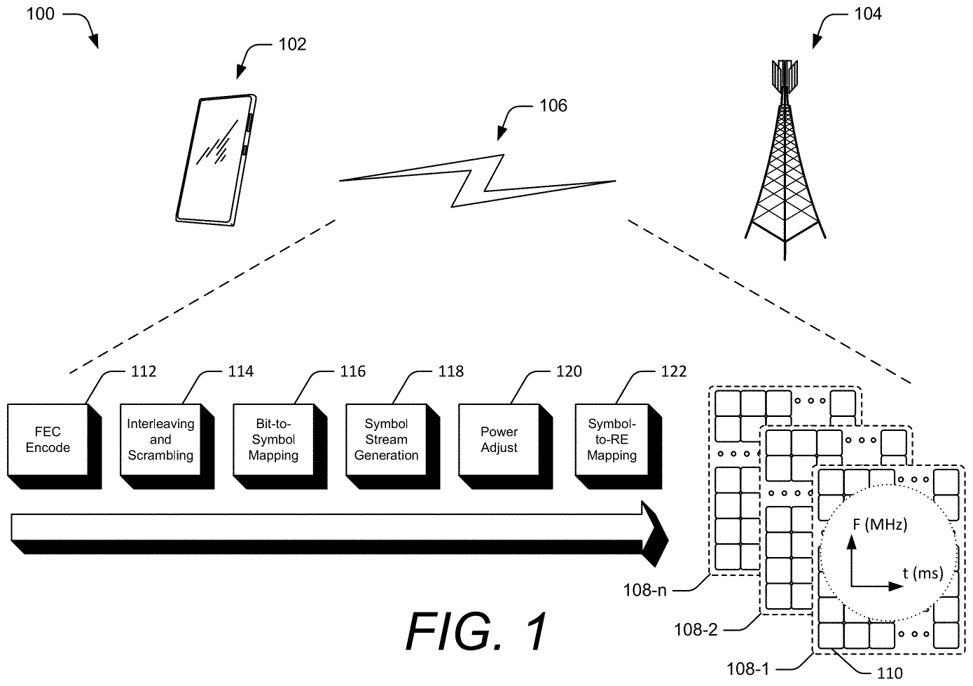

FIG. 1 illustrates an example operating environment 100 in which various aspects of multi-layer NOMA wireless communication for repeating transmission of a transport block can be implemented. The operating environment 100 includes a user equipment (UE) 102 (e.g., a user device) connecting to a base station 104 via a wireless link 106. Although illustrated as a smartphone, the user device 102 can be implemented as any suitable computing or electronic device, such as a mobile communication device, a modem, a cellular phone, a gaming device, a navigation device, a media device, a laptop computer, a desktop computer, a tablet computer, a smart appliance, a vehicle-based communication system, and the like. The base station 104 may be implemented as or include an Evolved Universal Terrestrial Radio Access Network Node B, E-UTRAN Node B, evolved Node B, eNodeB, eNB, a Next Generation Node B, (gNode B or gNB), a Long Term Evolution (LTE) system, an LTE-Advanced (LTE-A) system, an evolution of the LTE-A system, a 5G NR system, and the like. When implemented as part of a wireless network, the base station 104 may be configured to provide or support a macrocell, microcell, small cell, picocell, wide-area network, or any combination thereof. In various aspects of multi-layer NOMA wireless communication for repeating transmission of a TB, the base station 104 may be referred to as an eNB, a gNB, or relay (or vice versa).

The serving cell base station 104 communicates with the user device 102 via the wireless link 106, which may be implemented as any suitable type of wireless link. The wireless link 106 can include a downlink of data and control information communicated from the serving cell base station 104 to the user device 102 and/or an uplink of other data and control information communicated from the user device 102 to the serving cell base station 104. The wireless link 106 may include one or more wireless links or bearers implemented using any suitable communication protocol or standard, or combination of communication protocols or standards such as 3rd Generation Partnership Project Long-Term Evolution (3GPP LTE), 5G NR, and so forth.

The user device 102 may connect to a network, such as a Long Term Evolution (LTE) or a 5G NR wireless-communication network, provided by a wireless-communication network service provider through the base station 104 via the wireless link 106. Such a network may include a series of connections to, for example, routers, servers, other base stations, or communication hardware that enable the user device 102 to communicate and exchange data with other user devices.

As illustrated, the user device 102 can transmit multiple data streams (e.g., a multi-branch data stream) to the base station 104 via the wireless link 106. The multi-branch (also referred to herein as multi-layer) data stream is comprised of multiple data streams transmitted via resources of an air interface (e.g., physical resource blocks) 108-1 through 108-n. Each of the resources 108-1 through 108-n comprises multiple resource elements, such as resource element 110, which is defined for a particular time interval (such as a time interval measured in milliseconds) and a frequency range (such as a frequency range measured in Megahertz (MHz)) of the air interface.

As part of the multi-layer NOMA wireless communication for repeating transmission of a TB, the user device 102 may perform multiple operations to establish the multiple data streams. Such operations may include, for example, combinations of forward error correction and encoding 112, bit-level interleaving and scrambling 114, bit-to-symbol mapping 116, symbol stream generation 118, power adjustments 120, and symbol to resource element mapping 122.

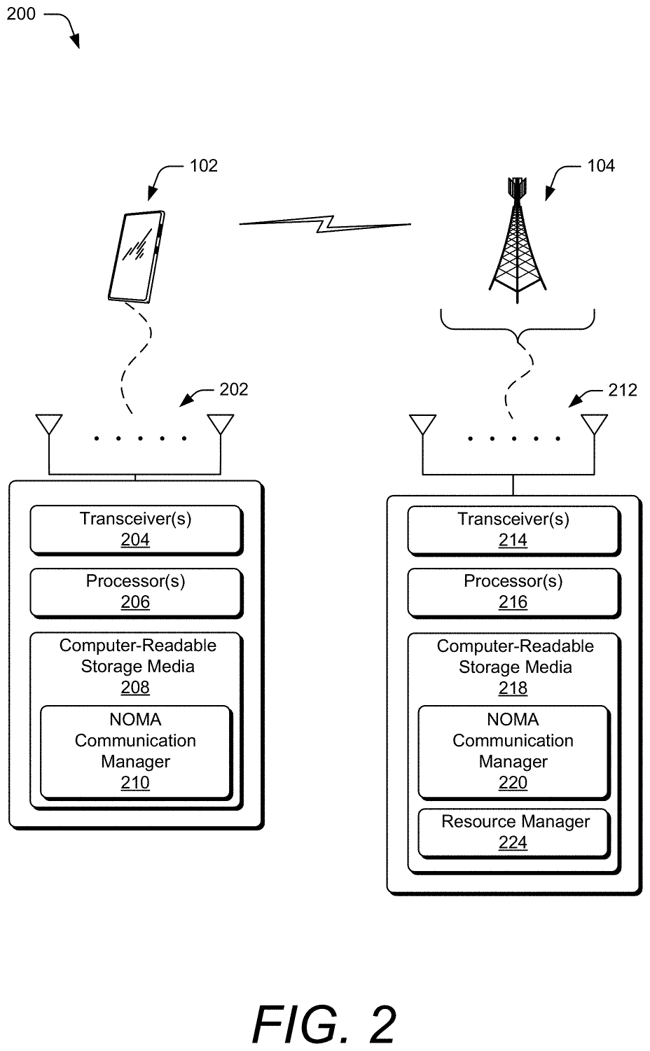

FIG. 2 illustrates example implementation 200 of a user device and a base station supporting various aspects of multi-layer NOMA wireless communication for repeating transmission of a TB. It should be noted that not all features of the user device and the serving cell base station are illustrated here for the sake of clarity. In other words, the user device and/or serving base station may also include any other suitable components to implement respective communication or processing functions of either device. The user device and the base station may be the user device 102 and the base station 104 of FIG. 1.

In this example, the user device 102 includes a Multiple Input Multiple Output (MIMO) antenna array 202 and one or more transceiver(s) 204. The transceiver(s) 204 may be, for example, one or more LTE transceivers or one or more 5G NR transceivers, or a combination of LTE transceivers and 5G NR transceivers. The MIMO antenna array 202 can be tuned to, and/or be tunable to, one or more frequency bands defined by the LTE and 5G NR communication standards and implemented by the transceiver(s) 204. Furthermore, the MIMO antenna array 202 can be configured to form transmission beams (e.g., directionally form beams for transmitting signals), which may be used to transmit respective data streams. By way of example and not limitation, the antenna array 202 can be implemented for operation in sub-gigahertz bands, sub-6 GHZ bands, and/or above 6 GHz bands that are defined by the 3GPP LTE and 5G NR communication standards. Alternatively, the transceiver 204 may be replaced with a receiver (or transmitter) and operations described herein as performed by the transceiver 204 may be performed by the receiver (or transmitter).

The user device 102 also includes processor(s) 206 and computer-readable storage media (CRM) 208. The processor 206 may be a single core processor or a multiple core processor composed of a variety of materials, such as silicon, polysilicon, high-K dielectric, copper, and so on. The computer-readable storage media described herein excludes propagating signals or carrier waves. The CRM 208 may include any suitable memory or storage device such as random-access memory (RAM), static RAM (SRAM), dynamic RAM (DRAM), non-volatile RAM (NVRAM), read-only memory (ROM), Flash memory, hard disk, or optical data storage device useful to store device data of the user device 102. The device data includes user data, multimedia data, applications, and/or an operating system of the user device 102, which are executable by processor(s) 206 to enable user interaction with the user device 102 or functionalities thereof.

The CRM 208 includes code or instructions for a user-device NOMA communication manager 210, which when executed by the processor 206, causes the user device 102 to perform functions that support management of multi-layer NOMA wireless communication for repeating transmission of a TB. Alternately or additionally, the NOMA communication manager 210 may be implemented in whole or part as hardware logic or circuitry integrated with or separate from other components of the user device 102.

The device diagram for the base station 104 shown in FIG. 2 includes a single network node (e.g., an E-UTRAN Node B or gNode B). The functionality of the base station 104 may be distributed across multiple network nodes and/or devices and can be distributed in any fashion suitable to perform the functions described herein. In this example, the base station 104 includes a MIMO antenna array 212 and a transceiver 214 for communicating with the user device 102. The MIMO antenna array 212 of the base station 104 may include multiple antennas that are configured similar to or different from each other. The MIMO antenna array 212 can be tuned to, and/or be tunable to, one or more frequency bands defined by the LTE and 5G NR communication standards and implemented by the transceiver 214. Furthermore, the transceiver 214 and the MIMO antenna array 212 can be configured to form transmission beams (e.g., use principles of constructive and destructive signal interference to directionally form beams transmitting downlink communications) originating from the base station 104.

The antenna array 212 of the serving cell base station 104 may include an array of multiple antennas that are configured similar to or different from each other. The antenna array 212 can be tuned to, and/or be tunable to, one or more frequency band defined by the 3GPP LTE and 5G NR communication standards, and implemented by the transceiver(s) 214. Additionally, the antennas 212 and/or the transceiver(s) 214 may be configured to support beamforming, such as massive multiple input multiple output (mMIMO), for the transmission and reception of communications with the user device 102.

The base station 104 includes a processor(s) 216 and computer-readable storage media (CRM) 218. The processor 216 may be a single core processor or a multiple core processor composed of a variety of materials, such as silicon, polysilicon, high-K dielectric, copper, and so on. The computer-readable storage media described herein is not configured to store propagating signals or carrier waves. CRM 218 may include any suitable memory or storage device such as random-access memory (RAM), static RAM (SRAM), dynamic RAM (DRAM), non-volatile RAM (NVRAM), read-only memory (ROM), or Flash memory useful to store device data of the user device 102.

The CRM 218 includes code or instructions for a base-station NOMA communication manager 220, which, when executed by the processor, cause the base station (e.g., the serving base station 104) to perform functions that support management of multi-layer NOMA wireless communication for repeating transmission of a TB. The CRM 218 further includes code or instructions for a resource manager 224, which can allocate resources (e.g., physical resource blocks) for communications with the user device 102. Alternately or additionally, the NOMA communication manager 220 or the resource manager 224 may be implemented in whole or part as hardware logic or circuitry integrated with or separate from other components of the base station 104.

In a NOMA scheme, a user device performs data transmission by using a multiple access (MA) resource. In at least one example, the MA resource includes a physical resource and an MA signature. The MA signature is an entity distinguishing its data stream from others in multi-branch transmissions. The multi-branch transmissions may be considered a plurality of NOMA layers (also referred to as a plurality of single transmissions), each of which transmits a single data stream on the same physical resource through NOMA. For example, some information bits are processed through the operations described in FIG. 1. The information bits can be divided by NOMA layers into multiple data streams, where each data stream is encoded with lower coding rate and/or lower modulation order. Existing NOMA schemes usually use one or more of the operations in FIG. 1 to provide the schemes with the MA signatures differentiating different NOMA layers, each of which takes one data stream. It should be noted that in the technical discussion about NOMA in 3GPP, some terms are used to describe “multi-branch”, such as “multi-layer”. Moreover, the term “NOMA layer” may be referred to as “NOMA branch”. It should be noted that “NOMA layers” mentioned in the document does not exclude a plurality of orthogonal transmissions.

In an example, each of a plurality of user devices uses an individual different MA signature to transmit data on the same physical resource. The base station may receive and distinguish different user device data streams on the same physical resource by identifying MA signatures of the data streams. MA signatures may be anything (e.g., orthogonal codes, spreading sequences, power, etc.) so that the receiver can use them to distinguish different data streams. MA resources mentioned in the document can be orthogonal or non-orthogonal resources.

In 4G LTE systems, preambles are transmitted by an asynchronous user device in order to make a base station acquire correct timing advance (TA) value from the user device during a random access procedure. After the user device has received the timing advance value from the base station during the random access procedure, the uplink (UL) of the user device is considered synchronized with the base station. In 5G NR systems, a user device can be allowed to synchronize with a base station without performing the random access procedure. The user device can directly transmit UL data along with a preamble while performing grant-free transmission. After the base station receives the data, it estimates the timing advance value through the accompanying preamble on a pre-transmission basis. Alternatively, the preambles may be used to make some UE/transmission-specific information (e.g., user equipment device identity (UE-ID), the number of retransmission attempts, modulation coding scheme (MCS), and/or redundancy version (RV), etc.) be implicitly given at receiver. In an example, both a base station and a user device identify that a preamble is used by a UE-ID (the preamble may be one-to-one mapped to the UE-ID). Therefore, the base station can know the UE-ID by detecting the presence of the preamble under the circumstance that the UE-ID is not explicitly signaled to the base station.

In the NOMA scheduling information (SI) in 5G NR, demodulation reference signals (DMRS) can be used for the detection of user device activity. The DMRS design of UL transmission has a significant impact on the ability of demodulation in NOMA. Alternatively, the DMRS may be mapped to various UE/transmission-specific information (e.g., UE-ID), the number of retransmission attempts, modulation coding scheme (MCS), and/or redundancy version (RV), etc.). The base station 104 can then obtain the related information by detecting the presence of corresponding DMRS.

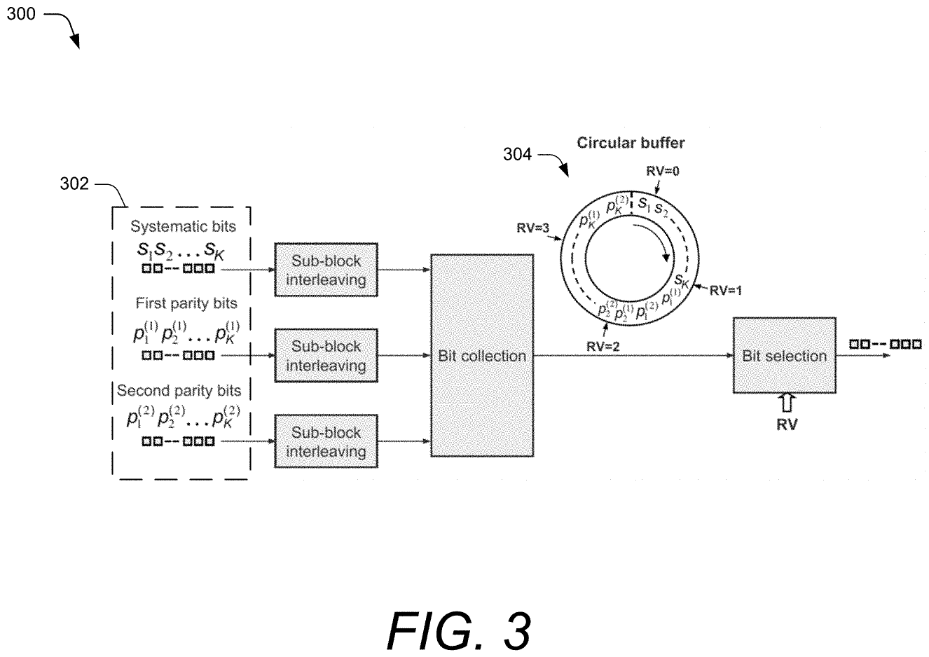

FIG. 3 illustrates an example diagram 300 representing rate-matching and HARQ functionality. In a Random Access Network (RAN) protocol architecture, a physical layer is responsible for coding, physical-layer Hybrid-Authentication Repeat Request (HARQ) processing, modulation, and multi-antenna processing. In addition, the physical layer handles mapping of transport channels to physical channels.

The physical layer provides services to the Medium Access Control (MAC) layer in the form of transport channels. In 4G LTE system, data transmission in downlink (DL) and uplink use the DL-Shared CHannel (DL-SCH) and UL-Shared CHannel (UL-SCH) transport-channel types respectively, where logical channels, including MAC control elements (CE), are multiplexed to form one (two in the case of spatial multiplexing) transport block(s) (TBs). Upon reception of a TB, the receiver attempts to decode the transport block and informs the transmitter about the outcome of the decoding operation by transmitting information about an acknowledgment (ACK) or a Negative Acknowledgement (NACK). In addition, if the transmitter attempts to perform a retransmission of the TB, the transmitter and the receiver utilized HARQ with a soft combining mechanism. In other words, an erroneously received transport block is stored in a buffer memory and later combined with the retransmission of the transport block to obtain a single, combined packet.

As illustrated in FIG. 3, inputs 302 (systematic bits, first parity bits, and second parity bits) are first separately interleaved and collected. The interleaved bits are then inserted into a buffer, such as a circular buffer 304, with the systematic bits inserted first, followed by alternating insertion of the first and second parity bits. Bit selection then extracts consecutive bits from the circular buffer to an extent that matches the number of available resource elements in resource blocks assigned for transmission. The exact set of bits to extract depends on a redundancy version (RV) corresponding to different starting points for extraction of coded bits from the circular buffer. The illustrated example includes four different alternatives for the redundancy version. A transmitter/scheduler selects the redundancy version and provides information about the selection as part of the scheduling assignment. Note that the rate-matching and HARQ functionality operates on the full set of code bits corresponding to one transport block and not separately on the code bits corresponding to a single code block.

Example Methods

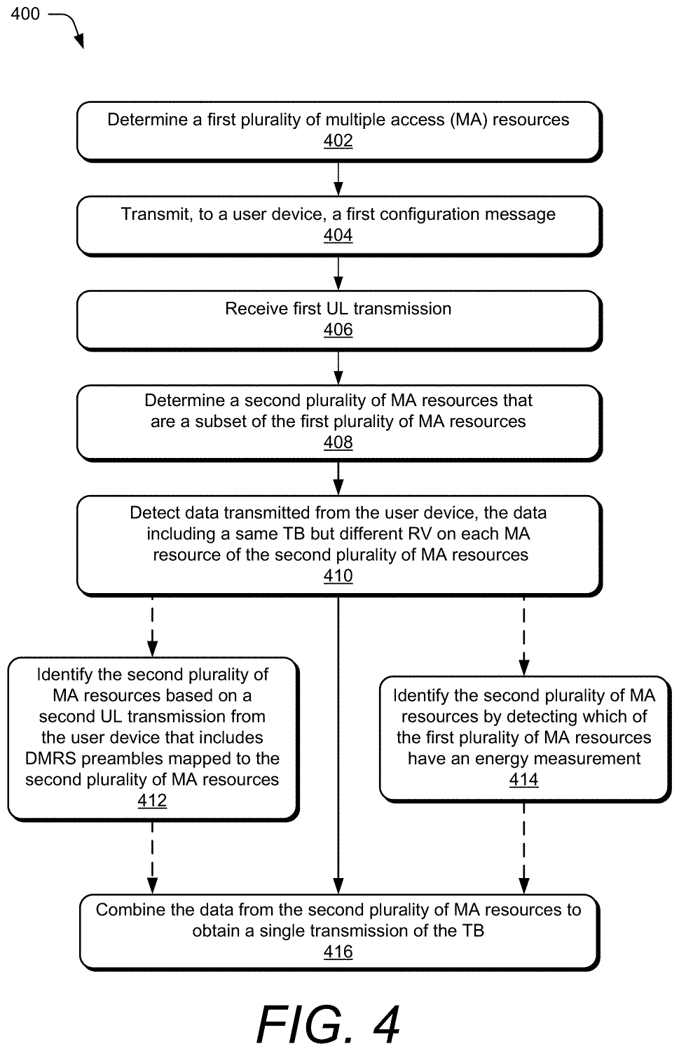

Example methods 400, 500, 600, and 700 are described with reference to FIGS. 4-7 in accordance with one or more aspects of multi-layer NOMA wireless communication for repeating transmission of a TB. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates an example method 400 for detecting data transmitted from a user device in accordance with various aspects of multi-layer NOMA wireless communication for repeating transmission of a TB. The method 400 is described in the form of a set of blocks 402-416 that specify operations that can be performed. However, operations are not necessarily limited to the order shown in FIG. 4 or described herein, for the operations may be implemented in alternative orders or in fully or partially overlapping manners. Operations represented by the method 400 may be performed by the base station 104 of FIG. 1 and performed using elements of FIGS. 1 and 2.

At 402, a base station (e.g., the base station 104), determines a first plurality of multiple-access (MA) resources. Determining the first plurality of multiple-access resources may include a processor (e.g., the processor 216) executing code or instructions stored in a computer-readable storage media 218 (e.g., executing the base-station NOMA communication manager 220 code and the resource manager 224 code stored in the CRM 218). The first plurality of MA resources may be, for example, one or more of the physical resource blocks 108-1 through 108-n of FIG. 1 and one or more NOMA layers or MA signatures.

At 404, the base station transmits, to a user device (e.g., the user device 102 of FIG. 1), a first configuration message. The transmission of the first configuration message may occur via a transceiver (e.g., the transceiver 214) and transmit information for configuring the user device 102 to transmit data in accordance with the determined, first plurality of MA resources.

At 406, the base station receives a first UL transmission. For example, the base station 104 receives a UL transmission from the user device 102 in accordance with the first configuration message.

At 408, the base station determines a second plurality of MA resources that are a subset of the first plurality of MA resources.

At 410, the base station detects data transmitted from the user device. The data includes the same transport block repeated on each of the second plurality of MA resources, where each MA resource of the second plurality of MA resources uses a different redundancy version.

Optionally, at 412, the base station identifies the second plurality of MA resources based on a second UL transmission from the user device that includes demodulation reference signals (DMRS) or preambles mapped to the second plurality of MA resources.

Alternatively, at 414, the base station can optionally identify the second plurality of MA resources by detecting which of the first plurality of MA resources have an energy measurement.

In yet another alternative, the base station can identify the second plurality of MA resources using a predefined mapping mechanism, or by considering the second plurality of MA resources to be the same MA resources as the first plurality of MA resources.

At 416, the base station combines the data from the second plurality of MA resources to obtain a single transmission of the TB. For example, the base station 104 can combine the transport block that was repeatedly transmitted from the user device 102 on each of the second plurality of MA resources to obtain a correctly-decoded TB.

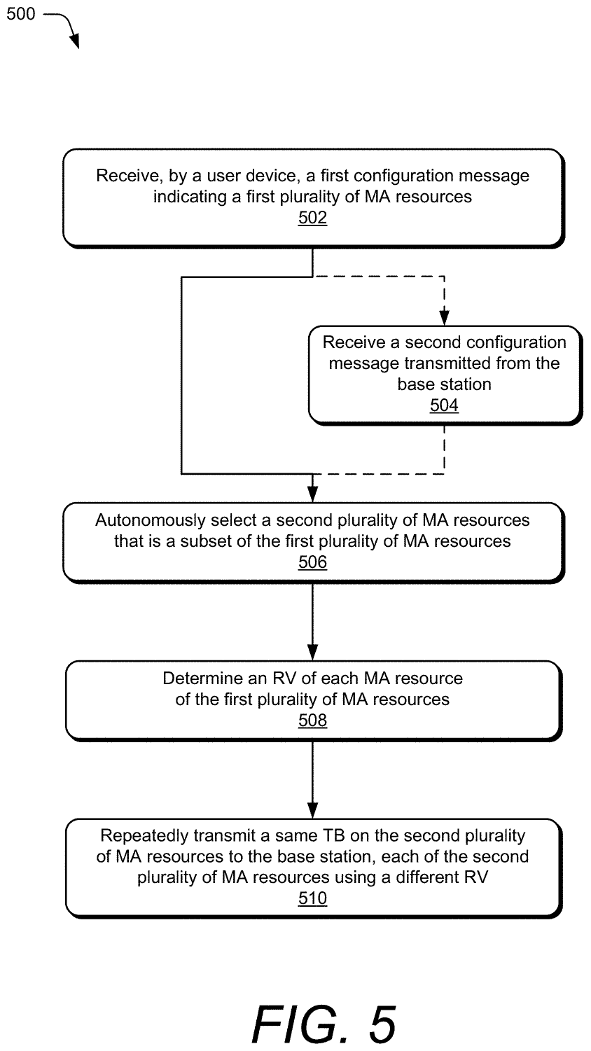

FIG. 5 illustrates an example method 500 for causing a base station to detect data transmitted from a user device in accordance with various aspects of multi-layer NOMA wireless communication for repeating transmission of a TB. The method 500 is described in the form of a set of blocks 502-510 that specify operations that can be performed. However, operations are not necessarily limited to the order shown in FIG. 5 or described herein, for the operations may be implemented in alternative orders or in fully or partially overlapping manners. Operations represented by the method 500 may be performed by the user device 102 of FIG. 1 and performed using elements of FIGS. 1 and 2.

At 502, a user device (e.g., the user device 102), receives a first configuration message transmitted from a base station (e.g., the base station 104). The message may be received via a transceiver (e.g., the transceiver 204) and include information for configuring the user device to transmit data in accordance with a first plurality of MA resources. The first plurality of MA resources may be, for example, one or more of the physical resource blocks 108-1 through 108-n of FIG. 1 and one or more NOMA layers or MA signatures.

At 504, the user device may, optionally, receive a second configuration message. The message may be received via the transceiver 204 and include information for configuring the user device 102 to transmit data in accordance with a second plurality of MA resources that is a subset of the first plurality of MA resources.

At 506, the user device autonomously selects a second plurality of MA resources that is a subset of the first plurality of MA resources. Selecting the second plurality of MA resources may include a processor (e.g., the processor 206) executing code or instructions stored in a computer-readable storage media 218 (e.g., executing the user-device NOMA Communication Manager 210 code stored in the CRM 218). Selecting the second plurality of MA resources may include indicating to the base station which of the first plurality of MA resources are selected as the second plurality of MA resources. Alternatively, the user device 102 can select the second plurality of MA resources based on information in the second configuration message.

At 508, the user device determines a redundancy version (RV) of each MA resource of the first plurality of MA resources. Determining the redundancy version of each of the first plurality of MA resources includes determining the redundancy version of each of the second plurality of MA resources. The redundancy version is different for each MA resource of the first plurality of MA resources.

At 510, the user device repeatedly transmits a same transport block on the second plurality of MA resources to the base station. In aspects, each of the second plurality of MA resources carries the same transport block and uses a different redundancy version. The transmission of the same transport block can cause the base station to detect multiple versions of the transport block based on the base station combining transmissions on the second plurality of MA resources to obtain a single transmission of the TB.

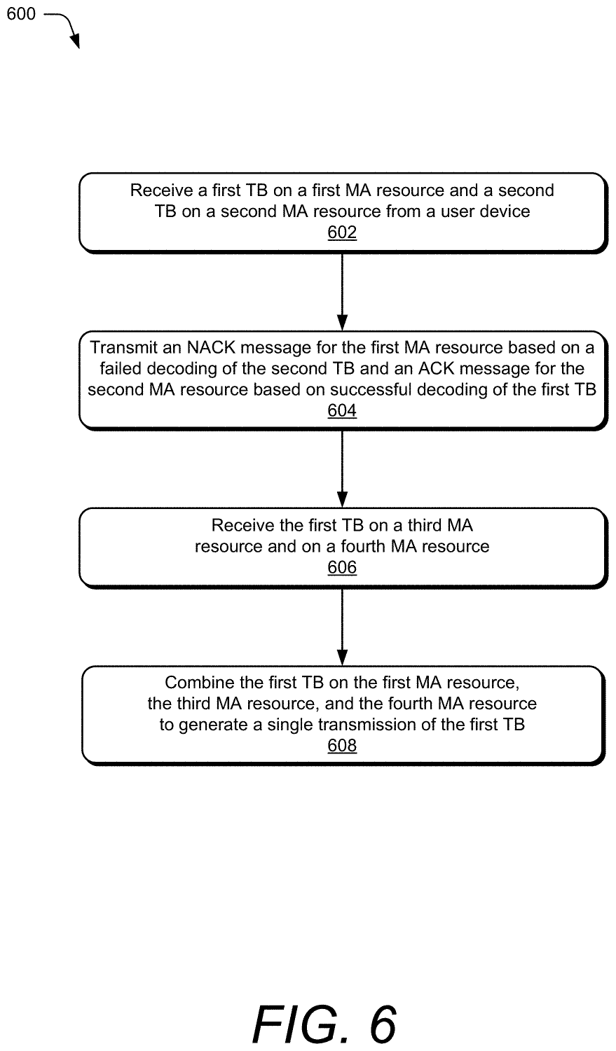

FIG. 6 illustrates an example method 600 for detecting data transmitted from a user device in accordance with various aspects of multi-layer NOMA wireless communication for repeating transmission of a TB. The method 600 is described in the form of a set of blocks 602-608 that specify operations that can be performed. However, operations are not necessarily limited to the order shown in FIG. 6 or described herein, for the operations may be implemented in alternative orders or in fully or partially overlapping manners. Operations represented by the method 600 may be performed by the base station 104 of FIG. 1 and performed using elements of FIGS. 1 and 2.

At 602, a base station receives a first transport block (TB1) on a first MA resource and a second transport block (TB2) on a second MA resource from the user device. In aspects, the first MA resource includes a first time-frequency resource and a first NOMA layer. The second MA resource may include the first time-frequency resource and a second NOMA layer.

If the base station fails to decode the TB1 but successfully decodes the TB2, then the method proceeds to block 604. At 604, the base station transmits an NACK message for the TB1 to the user device based on a failed decoding of the TB2. The base station also transmits an ACK message for the TB2 to the user device based on successful decoding of the TB1.

At 606, the base station receives the TB1 on a third MA resource and on a fourth MA resource from the user device. In aspects, the third MA resource includes a second time-frequency resource and the first NOMA layer. The fourth MA resource may include the second time-frequency resource and the second NOMA layer.

At 608, the base station combines the transmissions of the TB1 on the first MA resource, the third MA resource, and the fourth MA resource in order to obtain a single transmission of the TB1. In aspects, decoding of the error-correction code operates on the combined signal. In one example, the combining is performed after demodulation but before channel decoding.

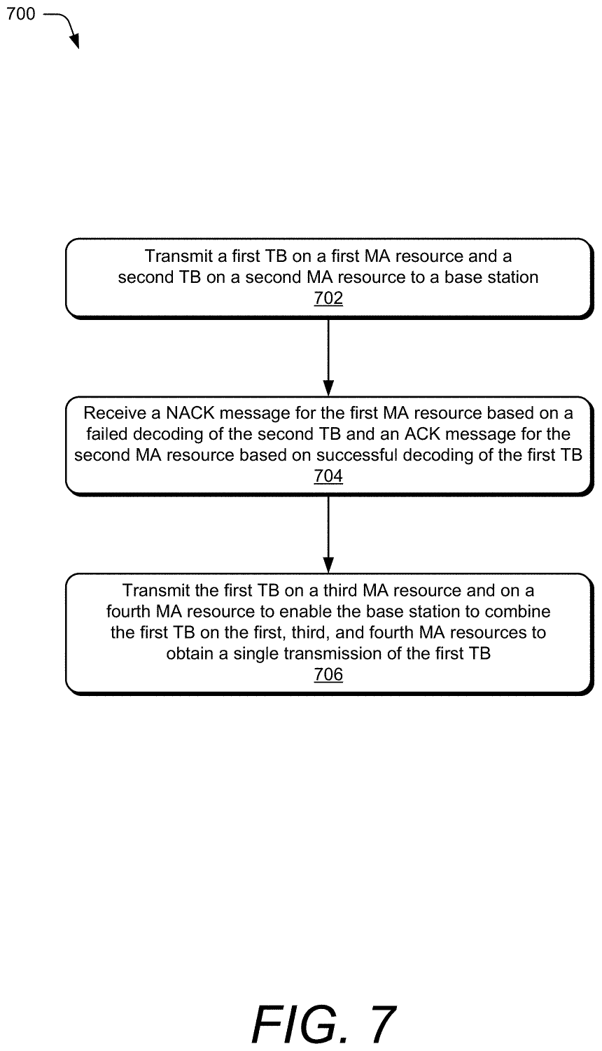

FIG. 7 illustrates an example method 700 for causing a base station to detect data transmitted from a user device in accordance with various aspects of multi-layer NOMA wireless communication for repeating transmission of a TB. The method 700 is described in the form of a set of blocks 702-706 that specify operations that can be performed. However, operations are not necessarily limited to the order shown in FIG. 7 or described herein, for the operations may be implemented in alternative orders or in fully or partially overlapping manners. Operations represented by the method 700 may be performed by the user device 102 of FIG. 1 and performed using elements of FIGS. 1 and 2

At 702, the user device transmits a first transport block (TB1) on a first MA resource and a second transport block (TB2) on a second MA resource to the base station. In aspects, the first MA resource includes a first time-frequency resource and a first NOMA layer. The second MA resource may include the first time-frequency resource and a second NOMA layer. Transmission of the TB1 on the first MA resource uses a first redundancy version, and transmission of the TB2 on the second MA resource uses a second redundancy version. The first redundancy version and the second redundancy version may be determined in advance by both the base station and the UE.

At 704, the user device receives an NACK of the TB1 and an ACK of the TB2 from the base station. The NACK is received based on a failed decoding of the TB1 by the base station and the ACK is received based on successful decoding of the TB2 by the base station.

At 706, the user device transmits the TB1 on a third MA resource and on a fourth MA resource to the base station. In aspects, the third MA resource includes a second time-frequency resource and the first NOMA layer. The fourth MA resource may include the second time-frequency resource and the second NOMA layer. The transmission of the TB1 on the third MA resource uses a third redundancy version, and the transmission of the TB1 on the fourth MA resource uses a fourth redundancy version. The third redundancy version and the fourth redundancy version may be determined in advance by both the base station and the user device.

In one example, the first redundancy version, the second redundancy version, the third redundancy version, and the fourth redundancy version are each determined in advance by both the base station and the user device. In an example, before the base station receives the TB1 and the TB2, the base station configures the first redundancy version, the second redundancy version, the third redundancy version, and the fourth redundancy version for the user device by using UE-specific signaling or broadcast transmission. Alternatively, the specification may indicate redundancy versions of the transmission and retransmission(s) of both TB1 and TB2. Therefore, the first redundancy version, the second redundancy version, the third redundancy version, and the fourth redundancy version may be known to both the base station and the user device in advance.

Interrelated, Underlying Techniques of the Methods

In general, the methods 400 and 500 accommodate combinations of interrelated, underlying techniques. Interrelations may include conditional dependencies of other techniques being performed within the methods 400 and/or 500, a sequence of specific techniques being performed within the methods 400 and/or 500, or the like. In addition, the methods 400 and 500 can be performed by the base station 104 and the user device 102, respectively. The interrelated, underlying techniques of methods 400 and 500 may include one or more of the below-listed aspects:

The first configuration message includes information about the first plurality of MA resources for a user device and is transmitted via UE-specific signaling (e.g., an RRC signaling, a Layer 1/Layer 2 (L1/L2) control signaling) or a broadcast transmission (e.g., system information). In aspects, each of the first plurality of MA resources includes a physical resource and one of a first plurality of NOMA layers/MA signatures. In this scenario, the combination of the physical resource and the one of the first plurality of NOMA layers is considered one of the first plurality of MA resources. Alternatively, each of the first plurality of MA resources includes an MA signature/NOMA layer and one of a first plurality of physical resources. In this scenario, the combination of the MA signature and one of the first plurality of physical resources is considered one of the first plurality of MA resources.

In one aspect, the base station determines the second plurality of MA resources by receiving and reading an Uplink Control Information (UCI) from the UE, which includes information indicating the second plurality of MA resources. In at least one example, if the UCI (or the Uplink L1/L2 control signaling) is on a physical uplink shared channel (PUSCH) and is received by the based station from the UE, then the UCI is received on one or more MA resource(s) on the first plurality of MA resources, and the one or more MA resource(s) are known in advance by both the base station and the UE. In one example, before determining the second plurality of MA resources, the base station provides the user device with information about which MA resource(s) the UCI is on by using UE-specific signaling or broadcast transmission. In another example, the specification illustrates which MA resource(s) on the first plurality of MA resources includes the UCI.

In aspects, a predefined mapping mechanism is created between the first plurality of MA resources and available Demodulation Reference Signal (DMRS)/preambles transmitted by the user device for UL transmission. In addition, when the user device performs UL transmissions, it simultaneously transmits one of the DMRS/preambles. The DMRS/preambles are one-to-one mapped to the first plurality of MA resources. Once the base station detects the presence of transmission of one of the DMRS/preambles from the UE, the base station can identify an MA resource to which the DMRS/preamble is mapped. In one example, the base station determines a message for the user device by using UE-specific signaling or broadcast transmission, and the message includes a mapping between the first plurality of MA resources and available DMRS/preambles.

In one example, both the base station and the user device can consider the second plurality of MA resources to be the same as the first plurality of MA resources. Therefore, the base station need not receive additional information of the second plurality of MA resources from the UE.

In one aspect, the base station does not receive any information about the second plurality of MA resources from the UE. Consequently, the base station can consider the second plurality of MA resources to be any one subset of the first plurality of MA resources.

In aspects, the user device repeatedly transmits one transport block on multiple MA resources (e.g., the second plurality of MA resources) to the base station, with each of the multiple MA resources carrying the same transport block with the same or different redundancy versions (RVs). In one example, the user device repeatedly transmits a transport block to the base station on a plurality of NOMA layers, and each of the plurality of NOMA layers carries the same transport block but uses different redundancy versions.

In an example, the base station receives a transport block from the user device by demodulating transmission on each of the second plurality of MA resources and combining the transmissions on the second plurality of MA resources to obtain a single transmission of the TB, with the second plurality of MA resources respectively having one of the redundancy versions. In addition, the base station decodes an error-correction code on the combined signal. It should be noted that the procedure of combining the transmissions is similar to HARQ with soft combining. In one example, the combining is done after demodulation but before channel decoding.

In another example, the base station detects a UL transmission by detecting the DMRS/preambles, and identifies some of the DMRS/preambles that are transmitted by the UE. The base station identifies the MA resources to which the DMRS/preambles are mapped. In addition, the base station determines that the MA resources are the second plurality of MA resources. The base station receives a transport block from the user device by demodulating transmission on each of the second plurality of MA resources and combining the transmissions on the second plurality of MA resources to obtain a single transmission of the TB, with each of the second plurality of MA resources having a redundancy version. Further, the base station decodes the error-correction code on the combined signal. It should be noted that the procedure of combining the transmissions is similar to HARQ with soft combining. In one example, the combining is done after demodulation but before channel decoding.

In an additional example, the base station monitors energy of each MA resource on the first plurality of MA resources. The base station identifies some of the MA resources on the first plurality of MA resources that have energy, and the base station then determines that these MA resources are the second plurality of MA resources. The base station receives a transport block from the user device by demodulating transmission on each of the second plurality of MA resources and combining the transmissions on the second plurality of MA resources to obtain a single transmission of the TB, with each of the second plurality of MA resources having a redundancy version. Further, the base station decodes the error-correction code on the combined signal. In one example, the combining is done after demodulation but before channel decoding.

In general, the method 500 accommodates combinations of interrelated, underlying techniques. Interrelations may include conditional dependencies of other techniques being performed within the method 500, a sequence of specific techniques being performed within the method 500, or the like. The interrelated, underlying techniques of method 500 may include one or more of the below-listed aspects:

A user device receives a configuration message about a first plurality of MA resources from a base station by receiving UE-specific signaling (e.g., an RRC signaling, a L1/L2 control signaling) or a broadcast transmission (e.g., system information). In one example, each of the first plurality of MA resources includes a physical resource and one of a first plurality of NOMA layers/MA signatures. Alternatively, each of the first plurality of MA resources includes an MA signature/NOMA layer and one of a first plurality of physical resources.

In aspects, the user device autonomously selects some MA resources from the first plurality of MA resources and considers that the MA resources are the same as the second plurality of MA resources. The user device determines to use the second plurality of MA resources to transmit one transport block repeatedly. The user device transmits a UCI, which includes information indicating the second plurality of MA resources, to the base station. In one example, if the UCI (or the Uplink L1/L2 control signaling) is on the PUSCH and is transmitted by the user device to the base station, then the UCI is transmitted on one or multiple MA resource(s) on the first plurality of MA resources, and the MA resource(s) are known in advance by both the user device and the base station. In at least one example, before showing the base station the second plurality of MS resources, the user device receives a configuration message indicating which MA resource(s) include the UCI by receiving UE-specific signaling (e.g., an RRC signaling, a L1/L2 control signaling) or a broadcast transmission (e.g., system information) from the base station.

In one aspect, when the user device performs UL transmissions, it simultaneously transmits one of the DMRS/preambles. The DMRS/preambles are one-to-one mapped to the first plurality of MA resources. Once the base station detects the presence of transmission of one of the DMRS/preambles from the UE, it identifies an MA resource to which the DMRS/preamble is mapped. The user device receives a configuration message from the base station by receiving UE-specific signaling or broadcast transmission, where the message indicates a mapping between the first plurality of MA resources and available DMRS/preambles. Using the mapping, the user device autonomously selects some MA resources from the first plurality of MA resources and treats them as if they are the second plurality of MA resources.

In another aspect, both the user device and the base station consider the second plurality of MA resources to be the same as the first plurality of MA resources. Therefore, the user device need not transmit additional information indicating the second plurality of MA resources to the base station.

Alternatively, the user device autonomously selects some MA resources from the first plurality of MA resources and treats them as if they are the second plurality of MA resources. In this example, the user device does not transmit any information about the second plurality of MA resources to the base station.

In aspects, the user device repeatedly transmits one transport block on multiple MA resources (e.g., the second plurality of MA resources) to the base station, with each of the multiple MA resources carrying the same transport block with the same or different redundancy versions. In one example, the user device repeatedly transmits a transport block to the base station on a plurality of NOMA layers, with each NOMA layer carrying the same transport block but using a different redundancy version.

In one example, the user device autonomously determines a redundancy version of each MA resource of the first/second plurality of MA resources and transmits a UCI that includes information indicating the redundancy version of each MA resource of the first/second plurality of MA resources to the base station. Accordingly, in this scenario, the redundancy versions of transmissions on the first/second plurality of MA resources are determined by the UE.

In another example, the user device receives a configuration message from the base station by receiving UE-specific signaling or broadcast transmission, where the message indicates the redundancy version of each MA resources of the first/second plurality of MA resources. Accordingly, in this scenario, the redundancy versions of transmissions on the first/second plurality of MA resources are determined by the base station.

In yet another example, the redundancy versions of the first plurality of MA resources are written in the specification and thus known in advance to both the user device and the base station.

The user device repeatedly transmits a same transport block on the second plurality of MA resources to the base station, where the second plurality of MA resources respectively have the determined redundancy versions. In this example, the second plurality of MA resources carry the same transport block but use different redundancy versions.

The user device transmits the DMRS/preambles that are mapped to the second plurality of MA resources to the base station. Then, the user device repeatedly transmits a same transport block on the second plurality of MA resources to the base station, with the second plurality of MA resources respectively having the determined redundancy versions.

In another example, the user device autonomously selects MA resources from the first plurality of MA resources and considers these MA resources to be the same as the second plurality of MA resources. Then, the user device repeatedly transmits a same transport block on the second plurality of MA resources to the base station, where the second plurality of MA resources respectively have the determined redundancy version.

In one example, the first plurality of MA resources may have one or more MA resource(s). The second plurality of MA resources may have one or more MA resource(s). In aspects, the first plurality of MA resources may be a plurality of NOMA layers on a time-frequency resource. The redundancy versions of transmissions on the first/second plurality of MA resources may be the same or different.

In at least one example, two user devices, respectively UE1 and UE2, perform the above-described operations. Both the UE1 and the UE2 are configured by the base station to use different MA resources when they receive the configuration message about the first plurality of MA resources (e.g., by receiving UE-specific signaling or a broadcast transmission), where both the MA resources used by UE1 and the MA resources used by UE2 are on the same time-frequency resources but are on different NOMA layers (e.g., the UE1 uses a first group of NOMA layers and the UE2 uses a second group of NOMA layers). In an example, some of the first group of NOMA layers are identical with some of the second group of NOMA layers, but the remaining NOMA layers of the first group of NOMA layers are different from the remaining NOMA layers of the second group of NOMA layers.

What is claimed is:

1. A method for detecting, by a base station, data transmitted from a user equipment, the method comprising:
determining, by the base station, a first plurality of multiple-access (MA) resources for the user equipment to use to transmit an uplink transmission;
transmitting, by the base station to the user equipment, a first configuration message that includes an indication of the first plurality of MA resources;
receiving, by the base station, a first uplink transmission corresponding to the first configuration message;
initiating, by the base station, a decoding operation on data in the first uplink transmission;
determining, by the base station, a second plurality of MA resources that are a subset of the first plurality of MA resources based on a failure to decode a portion of the data in the first uplink transmission, the portion of the data corresponding to the second plurality of MA resources;
transmitting, by the base station and based on the failure to decode the portion of the data, a negative acknowledgment for the portion of the data corresponding to the second plurality of MA resources;
detecting, by the base station, additional data transmitted from the user equipment, the additional data including a same transport block, but a different redundancy version, on each MA resource of the second plurality of MA resources; and
combining, by the base station, the additional data from the second plurality of MA resources to obtain a correctly decoded transport block.

2. The method of claim 1, wherein the first plurality of MA resources includes one or more physical resource blocks, and one or more non-orthogonal multiple access (NOMA) layers or MA signatures.

3. The method of claim 1, wherein the same transport block is repeated on each of the second plurality of MA resources.

4. The method of claim 1, further comprising:
identifying, by the base station, the second plurality of MA resources based on a second uplink transmission from the user equipment that includes demodulation reference signals or preambles mapped to the second plurality of MA resources.

5. The method of claim 1, further comprising:
identifying, by the base station, the second plurality of MA resources by detecting which of the first plurality of MA resources have an energy measurement.

6. The method of claim 1, further comprising:
identifying, by the base station, the second plurality of MA resources using a predefined mapping mechanism.

7. The method of claim 1, wherein:
the combining of the data includes combining the same transport block that was repeatedly transmitted from the user equipment on each of the second plurality of MA resources to obtain a correctly-decoded transport block.

8. A method for causing a base station to detect data transmitted from a user equipment, the method comprising:
receiving, by the user equipment, a configuration message indicating a first plurality of multiple access (MA) resources;
autonomously selecting, by the user equipment, a second plurality of MA resources that is a subset of a first plurality of MA resources based on a negative acknowledgment, received from the base station, corresponding to the second plurality of MA resources;
determining, by the user equipment, a redundancy version of each MA resource of the second plurality of MA resources; and
repeatedly transmitting, by the user equipment, a same transport block on each of the second plurality of MA resources to the base station, each of the second plurality of MA resources using a different redundancy version.

9. The method of claim 8, wherein the first plurality of MA resources includes one or more physical resource blocks, and one or more non-orthogonal multiple access (NOMA) layers or MA signatures.

10. The method of claim 9, further comprising:
prior to autonomously selecting the second plurality of MA resources, receiving a second configuration message including information usable by the user equipment to select the second plurality of MA resources, wherein the autonomously selecting the second plurality of MA resources is based on the information received in the second configuration message.

11. The method of claim 8, wherein the second plurality of MA resources includes a plurality of non-orthogonal multiple access (NOMA) layers each carrying the same transport block but using different redundancy versions.

12. The method of claim 8, further comprising:
transmitting an uplink control information (UCI) including information indicating a redundancy version of at least one of the first plurality of MA resources and at least one of the second plurality of MA resources.

13. The method of claim 8, further comprising:
receiving a second configuration message from the base station by receiving user equipment-specific signaling or a broadcast transmission, the second configuration message including a redundancy version of each of the first plurality of MA resources and each of the second plurality of MA resources.

14. A user equipment comprising:
a wireless transceiver; and
a processor; and
computer-readable storage media comprising instructions that, responsive to execution by the processor, cause the processor to implement a non-orthogonal multiple access (NOMA) communication manager configured to:
transmit, using the wireless transceiver, a first transport block on a first multiple-access (MA) resource and a second transport block on a second MA resource to a base station;
receive, using the wireless transceiver, a negative acknowledgment (NACK) message for the first MA resource based on a failed decoding of the first transport block at the base station and an acknowledgment (ACK) message for the second MA resource based on successful decoding of the second transport block at the base station; and
transmit the first transport block on a third MA resource and on a fourth MA resource to enable the base station to combine the first transport block on the first, third, and fourth MA resources to obtain a correctly decoded transport block.

15. The method of claim 14, wherein the first MA resource includes a first time-frequency resource and a first NOMA layer.

16. The method of claim 15, wherein the second MA resource includes the first time-frequency resource and a second NOMA layer.

17. The method of claim 16, wherein the third MA resource includes a second time-frequency resource and the first NOMA layer.

18. The method of claim 17, wherein the fourth MA resource includes the second time-frequency resource and the second NOMA layer.

19. The method of claim 14, wherein:
transmission of the first transport block uses a first redundancy version; and
transmission of the second transport block uses a second redundancy version.

20. The method of claim 19, wherein:
transmission of the first transport block on the third MA resource uses a third redundancy version; and
transmission of the first transport block on the fourth MA resource uses a fourth redundancy version.
